(19) United States
(12) Patent Application Publication
(10) Pub. No.: US 2008/0080701 A1
(43) Pub. Date: Apr. 3, 2008

(54) Adaptive Power Offloading for a Subscriber Line Interface Circuit

(76) Inventors: Marius Goldenberg, Austin, TX (US); Ion C. Tesu, Austin, TX (US); Douglas R. Frey, Bethlehem, PA (US); Yan Zhou, Austin, TX (US); Shuang Pan, Austin, TX (US); Jeffrey A. Whaley, Austin, TX (US)

Correspondence Address: DAVIS & ASSOCIATES, P.O. BOX 1093, DRIPPING SPRINGS, TX, 78620, US

(21) Appl. No.: 11/537,738

(22) Filed: Oct. 2, 2006

(51) Int. Cl. H04M 1/00

(52) U.S. Cl. 379/399.01

(57) ABSTRACT

An apparatus for offloading power includes a power offload element providing a supply drop from a first supply level to a second supply level. The supply drop varies in response to a control signal. A signal processor of a subscriber line interface circuit provides the control signal. A linefeed driver of the subscriber line interface circuit is coupled to receive the second supply level for driving a subscriber line.

### FIELD OF THE INVENTION

This invention relates to methods and apparatus for managing the power for devices requiring and providing supply levels that may vary, for example, in accordance with device operational state.

### BACKGROUND

A subscriber line interface circuit typically requires different power supply levels depending upon operational state. One supply level is required when the subscriber equipment is “on-hook” and another supply level is required when the subscriber equipment is “off-hook”. Yet another supply level is required for “ringing”.

In order to ensure sufficient supply levels, a power supply providing a constant or fixed supply level sufficient to meet or exceed the requirements of all of these states may be provided. Such a solution permits one or more SLICs to use a common power supply for at least two operational states.

One disadvantage of a fixed power supply architecture is that excess power is generated and must be dissipated as heat or otherwise wasted when a SLIC is not using a power supply level optimized for its particular operational state or for the particular line conditions. For example, the power supply must be capable of supporting the worst-case scenario such as a maximum subscriber line length provided for by specification. In the event the subscriber line is considerably shorter than the maximum expected length, the SLIC will be required to absorb the excess power. The resulting additional thermal load can be problematic for integrated circuits of the SLIC.

One alternative to sharing fixed power supplies is to provide a tracking power supply for each device. Each tracking power supply varies its supply level in accordance with the requirements of its associated device. This tracking power supply architecture is more power efficient than the shared fixed power supply architecture. Given that every device needs its own tracking power supply, however, the tracking power supply per device architecture may not be economical for a large number of SLICs.

### SUMMARY OF THE INVENTION

In one embodiment, an apparatus for offloading power includes a power offload element providing a supply drop from a first supply level to a second supply level. The supply drop varies in response to a control signal. A signal processor of a subscriber line interface circuit provides the control signal. A linefeed driver of the subscriber line interface circuit is coupled to receive the second supply level for driving a subscriber line.

In one embodiment, a method includes providing a power offload element contributing a supply drop to a first supply to provide a second supply, wherein the supply drop varies in accordance with a control signal. The second supply is provided as a linefeed supply for driving a subscriber line. The control signal is varied in accordance with one of the operational state or waveform associated with the subscriber line.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a subscriber line interface circuit.

FIG. 2 illustrates one embodiment of power offloading circuitry.

FIG. 3 illustrates one embodiment of a method for adaptive power offloading for a subscriber line interface circuit.

FIG. 4 illustrates one embodiment of power offloading in accordance with a change in state from on-hook to off-hook.

FIG. 5 illustrates one embodiment of power offloading in accordance with a subscriber line ringing waveform.

FIG. 6 illustrates one embodiment of a method of enabling power offloading in accordance with a state of the subscriber line.

FIG. 7 illustrates one embodiment of a plurality of subscriber line interface circuits with accompanying power offload elements sharing a first supply.

### DETAILED DESCRIPTION

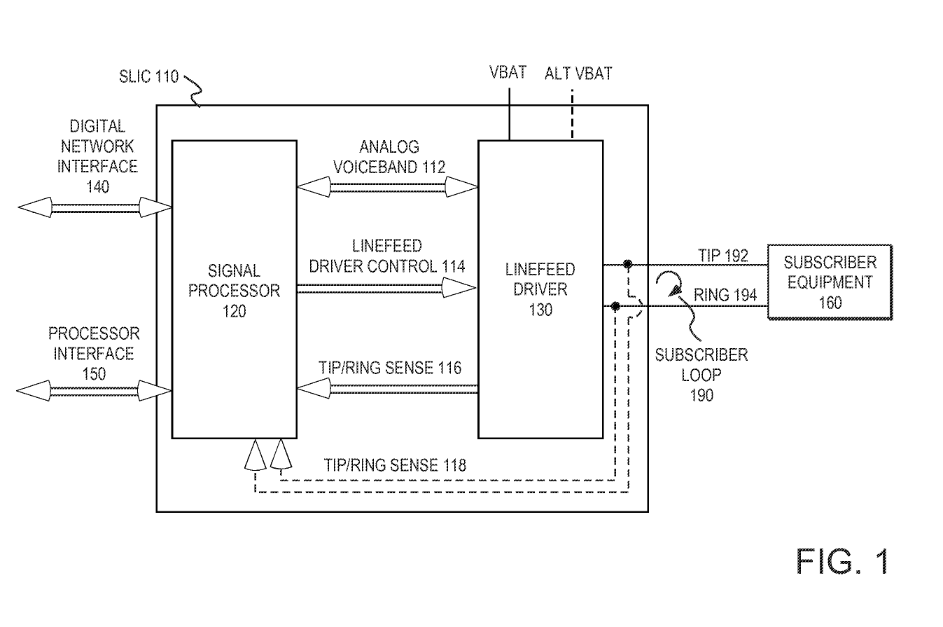

FIG. 1 illustrates one embodiment of a subscriber line interface circuit 110 associated with plain old telephone services (POTS) telephone lines. The subscriber line interface circuit (SLIC) provides an interface between a digital switching network of a local telephone company central exchange and a subscriber line comprising a tip 192 and a ring 194 line. A subscriber loop 190 is formed when the subscriber line is coupled to subscriber equipment 160 such as a telephone.

The subscriber loop 190 communicates analog data signals (e.g., voiceband communications) as well as subscriber loop “handshaking” or control signals. The subscriber loop state is often specified in terms of the tip 192 and ring 194 portions of the subscriber loop.

The SLIC is typically expected to perform a number of functions often collectively referred to as the BORSCHT requirements. BORSCHT is an acronym for “battery feed,” “overvoltage protection,” “ring,” “supervision,” “codec,” “hybrid,” and “test.” The term “linefeed” will be used interchangeably with “battery feed”. Modern SLICs may have battery backup, but the supply to the subscriber line is typically not actually provided by a battery.

The ring function, for example, enables the SLIC to signal the subscriber equipment 160. In one embodiment, subscriber equipment 160 is a telephone. Thus, the ring function enables the SLIC to ring the telephone.

In the illustrated embodiment, the BORSCHT functions are distributed between a signal processor 120 and a linefeed driver 130. Signal processor 120 is responsible for at least the ring control, supervision, codec, and hybrid functions. Signal processor 120 controls and interprets the large signal subscriber loop control signals as well as handling the small signal analog voiceband data and the digital voiceband data.

In one embodiment, signal processor 120 is an integrated circuit. The integrated circuit includes sense inputs for both a sensed tip and a sensed ring signal of the subscriber loop. The integrated circuit generates subscriber loop linefeed driver control signal in response to the sensed signals. The signal processor has relatively low power requirements and can be implemented in a low voltage integrated circuit operating in the range of approximately 5 volts or less.

Signal processor 120 receives subscriber loop state information from linefeed driver 130 as indicated by tip/ring sense 116. The signal processor may alternatively directly sense the tip and ring as indicated by tip/ring sense 118. This information is used to generate linefeed driver control 114 signals for linefeed driver 130. Analog voiceband 112 data is bi-directionally communicated between linefeed driver 130 and signal processor 120. In an alternative embodiment, analog voiceband signals are communicated downstream to the subscriber equipment via the linefeed driver but upstream analog voiceband signals are extracted from the tip/ring sense 118.

SLIC 110 includes a digital network interface 140 for communicating digitized voiceband data to the digital switching network of the public switched telephone network (PSTN). The SLIC may also include a processor interface 150 to enable programmatic control of the signal processor 120. The processor interface effectively enables programmatic or dynamic control of battery control, battery feed state control, voiceband data amplification and level shifting, longitudinal balance, ringing currents, and other subscriber loop control parameters as well as setting thresholds including ring trip detection and off-hook detection threshold.

Linefeed driver 130 maintains responsibility for battery feed to tip 192 and ring 194. The battery feed and supervision circuitry typically operate in the range of 40-75 volts. In some implementations the ringing function is handled by the same circuitry as the battery feed and supervision circuitry. In other implementations, the ringing function is performed by higher voltage ringing circuitry (75-150 Vᵣₘₛ).

Linefeed driver 130 modifies the large signal tip and ring operating conditions in response to linefeed driver control 114 provided by signal processor 120. This arrangement enables the signal processor to perform processing as needed to handle the majority of the BORSCHT functions. For example, the supervisory functions of ring trip, ground key, and off-hook detection can be determined by signal processor 120 based on operating parameters provided by tip/ring sense 116.

The linefeed driver receives a linefeed supply VBAT for driving the subscriber line for SLIC “on-hook” and “off-hook” operational states. An alternate linefeed supply (ALT VBAT) may be provided to handle the higher voltage levels (75-150 Vrms) associated with ringing.

VBAT may be provided as a fixed supply level. Typically VBAT is shared among a plurality of SLICs. Each SLIC is associated with its own subscriber line. The line conditions may vary greatly from one subscriber line to another. One subscriber line may be considerably shorter than another, for example. Shorter length subscriber loops require less power to drive. VBAT, however, is selected to accommodate a worst-case scenario for driving the subscriber line. Excess power must be dissipated by the SLIC. Excess power results in an increased thermal load that may be problematic when the increased thermal load is carried by an integrated circuit.

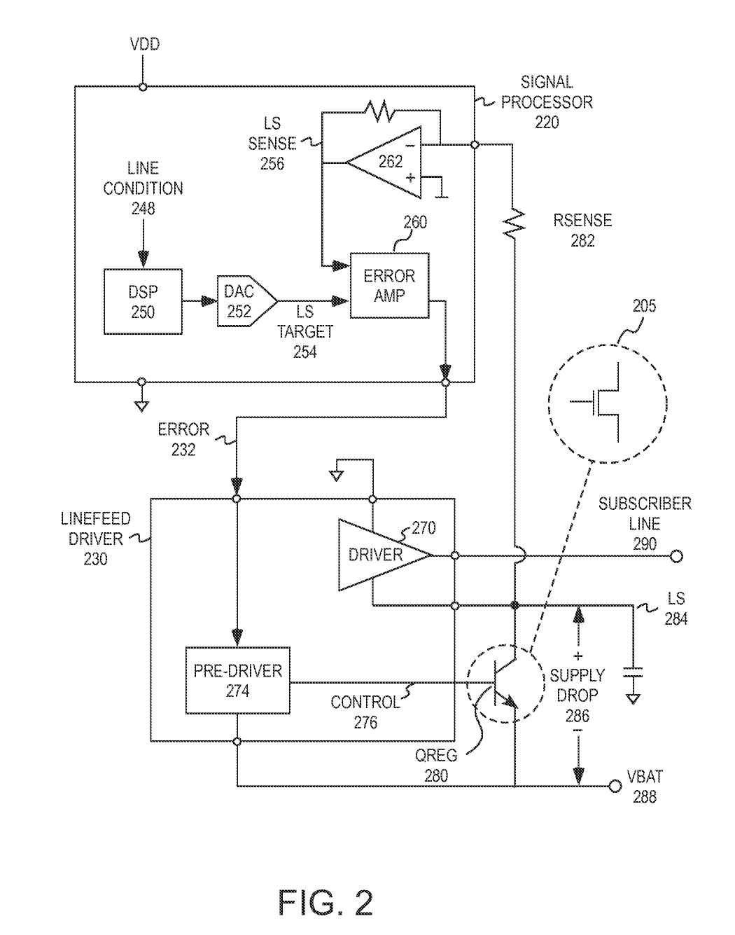

FIG. 2 illustrates one embodiment of a variable power offload that may be used with SLIC applications. In one embodiment, the signal processor 220 and the linefeed driver 230 reside within different integrated circuits.

In one embodiment, the signal processor 220 is fabricated as a low voltage complementary metal oxide semiconductor (CMOS) integrated circuit. In one embodiment, the linefeed driver 230 is fabricated as a higher voltage CMOS integrated circuit to support the higher power requirements associated with driving the subscriber line. The linefeed driver may alternatively be fabricated as a bipolar or bi-CMOS integrated circuit.

VBAT is typically around −48 volts. The signal processor relies on a power supply of VDD. In the illustrated embodiment, the magnitude of VBAT is much greater than the magnitude of VDD (i.e., |VBAT|>>|VDD|).

Although a tracking battery supply might be used to provide no more VBAT than necessary to meet the operational needs of a specific SLIC, practical implementations such a tracking battery supply would be required for each SLIC. A tracking battery supply (VBAT) per device may not be an economical architecture for a large number of SLICs. Thus practical implementations may tend to result in a shared fixed power supply (VBAT) for a plurality of SLICs.

One disadvantage of a shared fixed power supply architecture is that excess power is generated and must be dissipated as heat or otherwise wasted for each SLIC not using a power supply level optimized for its particular operational state or for its particular line conditions.

For example, the power supply must be capable of supporting the worst-case scenario such as a maximum subscriber line length provided for by specification. In the event the subscriber line is considerably shorter than the maximum expected length, the SLIC will be required to absorb the excess power. The resulting additional thermal load can be problematic for integrated circuits of the SLIC. Instead of a tracking battery supply for each SLIC, a power offload component is provided to dissipate excess power resulting from the battery supply.

A power offload element is provided in order to offload the power that would otherwise have to be dissipated by the linefeed driver 230. In the illustrated embodiment, the power offload element 280 is a bipolar junction transistor (i.e., “BJT” or “bipolar”) QREG. In an alternative embodiment, other power offload elements such as a field effect transistor (FET) 205 may be used. The power offload element is responsive to a control signal for varying the amount of power offloaded.

Generally, the amount of power required for the SLIC is dependent upon the operational state as well as the specific characteristics of the subscriber line associated with the SLIC. The amount of power offloading is regulated in accordance with these concerns. In particular, a target linefeed supply is calculated and the control signal varies the supply drop 286 from the power supply VBAT 288 to match the linefeed supply (LS 284) to the target linefeed supply (LS 254).

In the illustrated embodiment, power offloading control circuitry is distributed across the linefeed driver 230 and the signal processor 220. Based upon the line condition 248 of the subscriber line, the digital signal processor (DSP 250) computes a target linefeed supply level 254 for the subscriber line driver 270. The linefeed supply (LS 284) is used by driver 270 to drive the subscriber line 290. The linefeed supply level is sensed using RSENSE 282 and sense amplifier 262 to provide a sensed linefeed supply 256 as feedback.

The sensed linefeed supply 256 and target linefeed supply 254 are provided to error amplifier 260 to generate an error signal 232. In the illustrated embodiment, the error amplifier has analog inputs. Accordingly, the target linefeed supply level provided by the DSP is converted to an analog signal using a digital-to-analog converter (DAC 252) to generate a corresponding analog target linefeed supply 254.

Error signal 232 is a control signal for the power offload element 280. Instead of driving the power offload element directly, however, the error signal is provided to a pre-driver 274 for generating the control signal 276 for the power offload element. The pre-driver efficiently interfaces the error signal 232 to the power offload element (BJT, MOS, etc.) without compromising control loop dynamics. The pre-driver provides any necessary voltage-current conversion, scaling, and level shifting, but is otherwise responsive to the error signal. In one embodiment, the pre-driver resides with the linefeed driver 230 rather than the signal processor 220. In the illustrated embodiment, the pre-driver provides a voltage stand-off for the signal processor.

The control signal 276 varies in accordance with the error signal 232. The control signal is provided to the base of transistor QREG. LS 284 is moved relative to VBAT 288 by varying the error/control signal. The pre-driver provides a voltage standoff between the signal processor and the power offload element. When power offloading is disabled, the supply drop contributed by the power offload element is relatively negligible such that LS is approximately the same as VBAT.

FIG. 2 thus illustrates a power offload element (QREG) providing a supply drop from a first supply level (VBAT) to a second supply level (LS), the supply drop varying in response to a control signal. The signal processor 220 provides the control signal. The linefeed driver is coupled to receive the second supply level for driving the subscriber line. The power offload element 280 is external to any signal processor integrated circuit or linefeed driver integrated circuit. The control signal permits offloading at least some of the excess power to the power offload element for consumption. The associated thermal energy is thus dissipated by the power offload element rather than the integrated circuits.

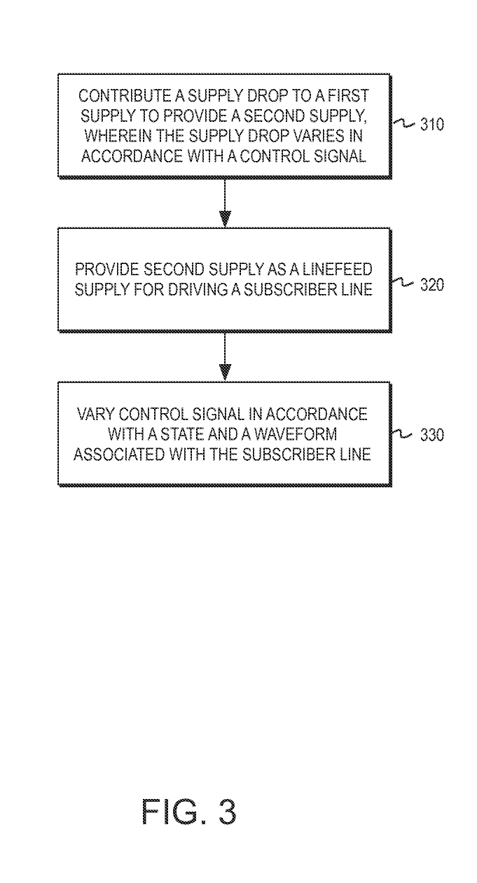

FIG. 3 illustrates one embodiment of a method for offloading power. A power offload element contributes a supply drop to a first supply to provide a second supply in step 310. The supply drop varies in accordance with a control signal. In step 320, the second supply is provided as a linefeed supply for driving a subscriber line. The control signal is varied in accordance with a state and a waveform associated with the subscriber line in step 330. The control signal may be generated by a signal processor of a SLIC. The linefeed supply may be provided to a linefeed driver of a SLIC. In one embodiment, the signal processor and linefeed driver are embodied as distinct integrated circuits within separate integrated circuit packages.

Referring to FIGS. 2-3, the linefeed supply of step 320 is the supply for driver 270. The linefeed supply is not the signal being driven by driver 270, although the difference between the two may be small depending upon the algorithm used by the DSP 250 for adaptive power offloading.

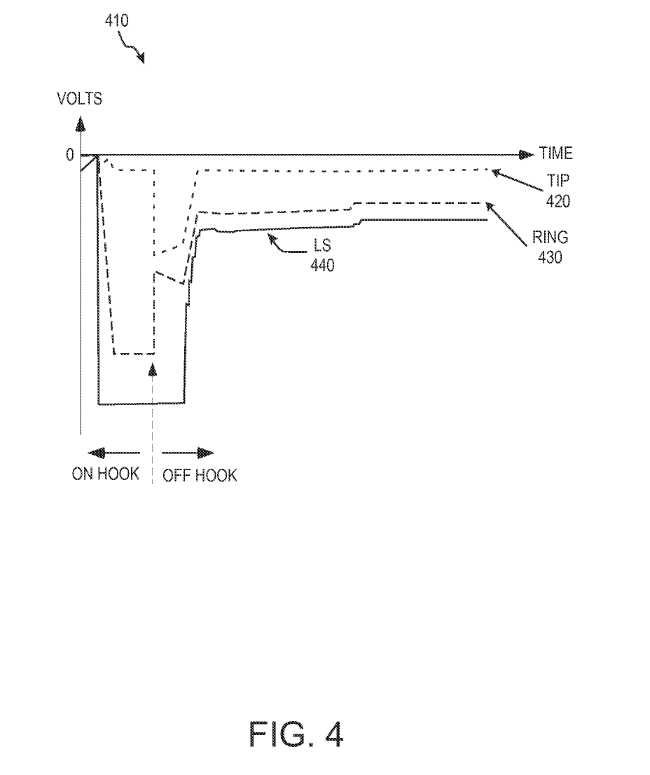

FIG. 4 illustrates power offloading in accordance with subscriber line waveforms 410 associated with a change in state. The change in the tip 420 and ring 430 indicate that the subscriber equipment has changed from an on-hook state to an off-hook state. The linefeed supply (LS 440) is varied in response to the subscriber loop tip and ring waveforms.

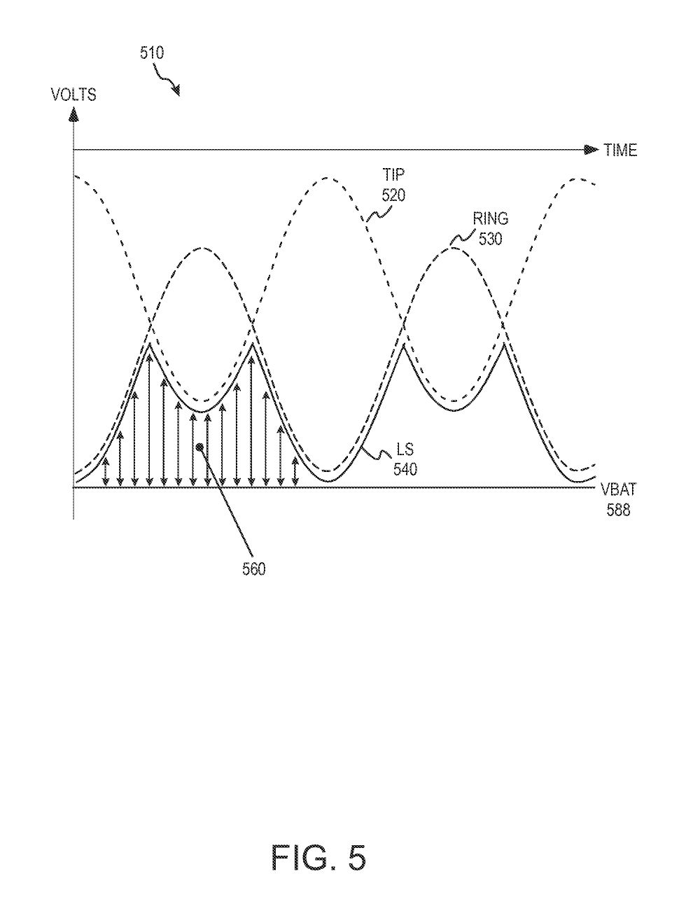

FIG. 5 illustrates power offloading for a ringing signal waveform 510. Typically, a sinusoidal waveform is applied to each of the tip and ring lines during ringing. Differential signaling permits the use of waveforms with half the amplitude that would otherwise be necessary. The tip 520 and ring 530 sinusoidal waveforms are phase shifted and have D.C. offsets relative to each other. The power offload element is controlled to provide a supply drop from VBAT 588 for yielding the linefeed supply (LS 540). Region 560 is indicative of the excess power dissipated by the power offload element. This excess power would previously have been dissipated by the linefeed driver.

With respect to FIGS. 4 and 5, any reduction of the linefeed supply level to the level required by the linefeed driver will result in power offloading and thus avoidance of unnecessary thermal loading of the linefeed driver. The linefeed supply may closely track the subscriber line waveform as indicated in FIG. 5. Alternatively, the linefeed supply may be more coarsely controlled as illustrated in FIG. 4. The state associated with the subscriber line impacts how closely the power offloading tracks the subscriber line waveform.

For example, the SLIC initiates ringing and thus can readily regulate how well power offloading tracks the ringing waveform. An off-hook state, however, is initiated by the subscriber equipment rather than the SLIC. The SLIC must first determine that the change in conditions of the subscriber line accurately represents a transition from on-hook to off-hook. As a result, the control algorithm might incorporate delay or debounce features that are unnecessary for ringing. The debounce feature requires the state to be maintained for a period of time before power offloading tracks the waveform. The delay feature time-shifts the tracking.

The amount of supply overhead (i.e., proximity of tracking to waveform) may also change depending upon the state. Distortion of voiceband communications may be highly undesirable, however, a distorted ringing signal may be little more than an annoyance. In addition to supply level overhead, maximum or minimum supply levels may be set. In general the control algorithm executed by the DSP may rely upon state-specific parameters including: delay, debounce interval, overhead, upper supply level, lower supply level, etc.

Some subscriber line states are relatively low-power states. Power offloading may not be necessary in these states. For example, if the subscriber equipment is “on-hook” and the SLIC is not ringing the subscriber equipment, then no power offloading is necessary. In one embodiment, no power offloading except when the subscriber line state is one of a pre-defined set of power offload enabled states.

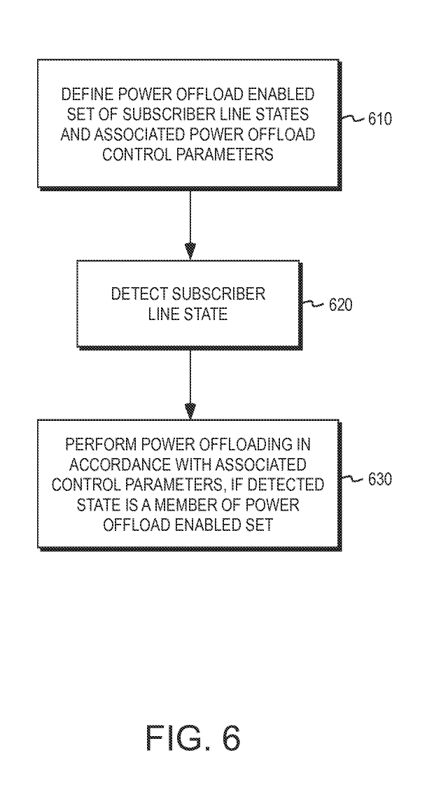

FIG. 6 illustrates one embodiment of a method of enabling power offloading in accordance with a state of the subscriber line. A power offload enabled set (P_{ENABLED}) of subscriber line states and associated power offload control parameters is defined in step 610. The control parameters might include, for example: upper threshold, lower threshold, overhead, delay, debounce interval, etc. The subscriber line state is detected in step 620. Power offloading is performed in step 630 only if the detected state (D) is a member of the power offload enabled set (i.e., D ∈ P_{ENABLED}). In one embodiment, the power offload enabled set includes at least one of a ringing state, an off-hook state, and a transitioning from on-hook to off-hook state.

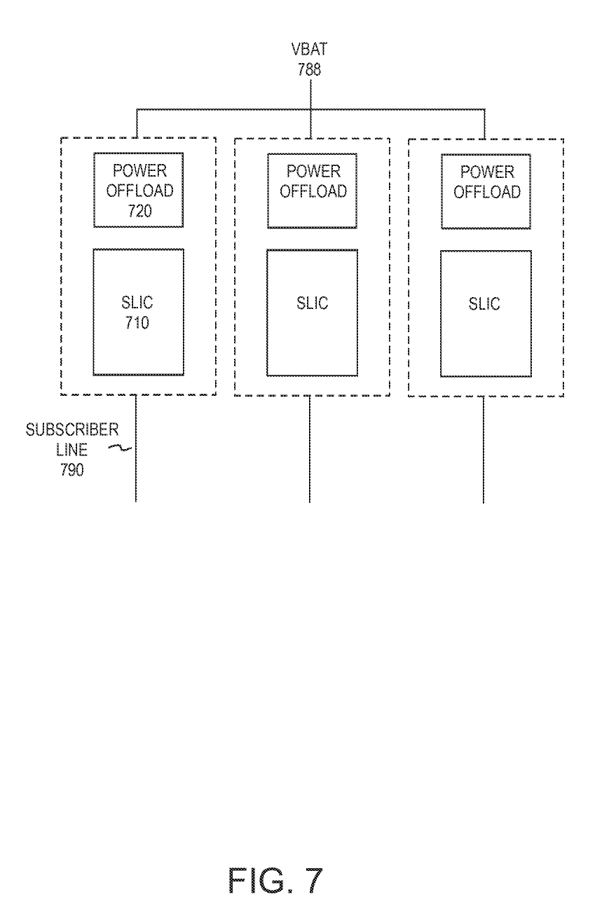

FIG. 7 illustrates one embodiment of a plurality of subscriber line interface circuits with accompanying power offload elements sharing a first supply (VBAT 788). Each SLIC 710 has an associated power offload element 720. Each SLIC 710 controls its associated power offload element to adaptively offload power for that SLIC depending upon the waveform or state associated with the subscriber line 790 for that SLIC.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. An apparatus comprising:
a power offload element providing a supply drop from a first supply level to a second supply level, the supply drop varying in response to a control signal;
a signal processor of a subscriber line interface circuit providing the control signal; and
a linefeed driver of the subscriber line interface circuit coupled to receive the second supply level for driving a subscriber line.

2. The apparatus of claim 1 wherein the power offload element is a transistor.

3. The apparatus of claim 1 wherein the linefeed driver is an integrated circuit.

4. The apparatus of claim 3 wherein the integrated circuit is fabricated as one of a bipolar, complementary metal oxide semiconductor (CMOS), or bi-CMOS integrated circuit.

5. The apparatus of claim 1 wherein the signal processor is an integrated circuit.

6. The apparatus of claim 5 wherein the integrated circuit is fabricated as a complementary metal oxide semiconductor (CMOS) integrated circuit.

7. The apparatus of claim 1 wherein the control signal varies the supply drop in accordance with a waveform associated with the subscriber line.

8. The apparatus of claim 1 wherein the control signal is responsive to at least one of a ringing waveform, an on-hook-to-off-hook waveform, and an off-hook waveform associated with the subscriber line.

9. The apparatus of claim 1 wherein the linefeed driver is an integrated circuit, wherein the signal processor is an integrated circuit, wherein the power offload element resides external to any integrated circuit of either the linefeed driver or the signal processor.

10. A method comprising:
(a) providing a power offload element contributing a supply drop to a first supply to provide a second supply, wherein the supply drop varies in accordance with a control signal;
(b) providing the second supply as a linefeed supply for driving a subscriber line; and
(c) varying the control signal in accordance with a state and a waveform associated with the subscriber line.

11. The method of claim 10 wherein the control signal is generated by an integrated circuit signal processor of a subscriber line interface circuit, wherein the linefeed supply is provided to an integrated circuit linefeed driver of the subscriber line interface circuit.

12. The method of claim 10 wherein the signal processor is fabricated as a complementary metal oxide semiconductor (CMOS) integrated circuit.

13. The method of claim 10 wherein the linefeed driver is fabricated as one of a bipolar, complementary metal oxide semiconductor (CMOS), or bi-CMOS integrated circuit.

14. The method of claim 10 wherein the linefeed driver and the signal processor reside within distinct integrated circuit packages.

15. The method of claim 10 wherein the linefeed driver is an integrated circuit, wherein the signal processor is an integrated circuit, wherein the power offload element resides external to any integrated circuit of either the linefeed driver or the signal processor.

16. The method of claim 10 wherein the control signal is responsive to at least one of a ringing waveform, an on-hook-to-off-hook waveform, and an off-hook waveform associated with the subscriber line.

17. A method comprising:
(a) defining a power offload enabled set of subscriber line states and associated power offload control parameters;
(b) detecting a subscriber line state; and
(c) performing power offloading in accordance with the associated control parameters, if the detected state is a member of the power offload enabled set.

18. The method of claim 17 wherein the power offload enabled set includes a ringing state.

19. The method of claim 17 wherein the power offload enabled set includes an off-hook state.

20. The method of claim 17 wherein the control parameters include at least one of: delay, debounce interval, overhead, upper supply level, and lower supply level.

21. The method of claim 17 wherein the power offloading is responsive to at least one of a ringing waveform, an on-hook-to-off-hook waveform, and an off-hook waveform associated with the subscriber line.
